(19) United States
(12) Patent Application Publication
(10) Pub. No.: US 2007/0000079 A1
(43) Pub. Date: Jan. 4, 2007

(54) Electric toothbrush

(76) Inventors: Toyokazu Mori, Osaka (JP); Seiji Kita, Osaka (JP); Syoko Uesaki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/561,542

(22) PCT Filed: Jun. 17, 2004
(86) PCT No.: PCT/JP04/08535

§ 371 Date: Dec. 19, 2005

(30) Foreign Application Priority Data
Jun. 20, 2003 (JP) 2003-177337

(51) Int. Cl. A61C 17/34

(52) U.S. Cl. 15/22.2

(57) ABSTRACT

An object is to provide an electric toothbrush superior in plaque removal, producible at low costs, and utilized without damaging gum even by a patient with gingivitis. In the electric toothbrush (10) making brushing possible by linearly moving a tufted portion (31), the product of the distance (mm) of movement of the tufted portion (31) and the frequency (times) of back-and-forth motion per minute is set in the range of 3000-9000. Further, the distance ((x) mm) of movement of the tufted portion (32) and the frequency ((y) times) of back-and-forth motion per minute are set in a range which satisfies the following formula: y=ax+b, where a=−3000, 10000≦b≦12500, x>0.

### BACKGROUND ART

The present invention relates to an electric toothbrush.

Electric toothbrushes comprising conversion means, which converts the rotary movement of a rotation shaft of a motor into a back-and-forth movement of the output shaft in the axial direction via a crank mechanism, gear mechanism and cam mechanism, have been widely used (see, for example, Japanese Patent Publication No. H4-364806). In the electric toothbrushes of this type, usually the distance of movement of tuft connecting the output shaft is set at 3-7 mm and the frequency of back-and-forth motion of the output shaft per minute is set at 1,000-3,000.

In recent years, electric toothbrushes with the distance of movement of tuft connecting the output shaft of about 1 mm and the frequency of back-and-forth motion of the output shafts per minute of about 15,000 attained by using a linear drive or magnetic forces have also come to use.

The electric toothbrush described in Japanese Patent Publication No. H4-364806 can be driven by a common DC electric motor driven, e.g., by a battery. Therefore, the electric toothbrush can be manufactured at a low cost. Furthermore, such an electric toothbrush also indicates a good plaque removal. However, the problem is that if the toothbrush is used by a patient with gingivitis, the gum is damaged due to the distance of movement of tuft is too large.

On the other hand, in the electric toothbrush using a linear drive or magnetic forces, the distance of movement of tuft connecting the output shaft is as small as 1 mm, therefore damage to the gum is decreased. However, the plaque removal is degraded by comparison with that of the usual electric toothbrush. Another problem is that production cost is increased because special parts are required.

It is an object of the present invention to provide an electric toothbrush superior in plaque removal, producible at a low cost, and utilized without damaging gum even by a patient with gingivitis.

### DISCLOSURE OF THE INVENTION

The applicant considered various uses of tools for oral hygiene and conducted a comprehensive study of electric toothbrushes that can be advantageously used even by a patient with gingivitis and can increase plaque removal. The results obtained demonstrated that this object can be attained by setting appropriately the distance of movement of tuft and the frequency of back-and-forth motion. This finding led to the creation of the present invention. In the present specification, the frequency of back-and-forth motion means the number of cycles, where one back-and-forth linear movement of the tufted portion is taken as one cycle. Furthermore, the distance of movement of tuft means the distance (amplitude), in millimeter units, of back-and-forth linear movement of the tufted portion in the electric toothbrush.

In the first electric toothbrush of the present invention, in which brushing is enabled by back-and-forth linear movement of a tufted portion, the product of the distance (mm) of movement of the tufted portion and the frequency (times) of back-and-forth motion per minute is set in the range of 3,000-9,000.

With the first electric toothbrush, plaque removal can be superior over a wide range from low frequency to high frequency.

Here, a more preferred range for setting the product of the distance (mm) of movement of the tufted portion and the frequency (times) of back-and-forth motion per minute is 4,500-7,500.

In the second electric toothbrush of the present invention, in which brushing is enabled by back-and-forth linear movement of a tufted portion, the distance, x (mm), of movement of the tufted portion and the frequency, y (times), of back-and-forth motion per minute are set in a range satisfying the following formula.
y=ax+b,
Where a=−3000, 10,000≦b≦12,500, x>0.

With this electric toothbrush, plaque removal can be superior over a wide range from low frequency to high frequency.

Here setting the distance of movement of the tufted portion to 0.3-0.7 mm and setting the frequency of back-and-forth motion per minute to 8,000-13,000 are embodiments.

In the third electric toothbrush of the present invention, in which brushing is enabled by back-and-forth linear movement of a tufted portion, the distance of movement of the tufted portion is set at 0.3-0.7 mm and the frequency of back-and-forth motion per minute is set at 8,000-13,000.

In the third electric toothbrush, because the distance of movement of the tufted portion is set at 0.3-0.7 mm, the electric toothbrush can be used even by a patient with gingivitis, without damaging the gum, and because the frequency of back-and-forth motion per minute is set at 8,000-13,000, a common motor that can be purchased at a low cost can be used and the production cost of the electric toothbrush can be reduced.

In the preferred embodiments of the first and second electric toothbrushes, the filaments in which the tip portions of at least 30% or more of all tufted filaments are split into a plurality of portions are used, and a DC electric motor is used as means for moving the tufted portion.

In the first electric toothbrush of the present invention, because the product of the distance (mm) of movement of the tufted portion and the frequency (times) of back-and-forth motion per minute is set in the range of 3000-9000, plaque removal can be superior over a wide range from low frequency to high frequency.

The plaque removal ratio can be further increased by setting the product of the distance (mm) of movement of the tufted portion and the frequency (times) of back-and-forth motion per minute in the range of 4,500-7,500.

In the second electric toothbrush of the present invention, in which brushing is enabled by moving a tufted portion, because the distance, x (mm), of movement of the tufted portion and the frequency, y (times), of back-and-forth motion per minute are set in a range satisfying the following formula: y=ax+b, where a=−3000, 10,000=b=12,500, plaque removal can be superior over a wide range from low frequency to high frequency. Here, if the distance of movement of the tufted portion is set at 0.3-0.7 mm, the electric toothbrush can be used even by a patient with gingivitis, without damaging the gum, while improving the plaque removal.

If the frequency of back-and-forth motion of the tufted portion per minute is set at 8,000-13,000, a common motor that can be purchased at a low cost can be used and the production cost of the electric toothbrush can be reduced, while improving the plaque removal.

In the third electric toothbrush, because the distance of movement of the tufted portion is set at 0.3-0.7 mm and the frequency of back-and-forth motion per minute is set at 8,000-13,000, the electric toothbrush can be used even by a patient with gingivitis, without damaging the gum and a common motor that can be purchased at a low cost can be used and the production cost of the electric toothbrush can be reduced, while improving the plaque removal.

If the filaments in which the tip portions of at least 30% of all tufted filaments are split into a plurality of portions are used, because the roots of the filaments are stable, the motions can be sufficiently transmitted to the tips.

If a DC electric motor is used as means for moving the tufted portion, an electric toothbrush that can be produced at a low cost can be realized.

### BRIEF DESCRIPTION OF THE DRAWINGS

FIG. 1 is a longitudinal sectional view of the electric toothbrush;

FIG. 2 is an explanatory drawings of the conversion means of the electric toothbrush;

FIG. 3 is a front view of the device for evaluation;

FIG. 4 is a top view of the device for evaluation;

FIG. 5 is an explanatory drawing of the teeth which are evaluated;

FIG. 6 is an explanatory drawing of interproximal portion of the teeth; and

FIG. 7 is a graph illustrating the relationship between the distance of movement of the tuft and the frequency of back-and-forth motion in interproximal portion.

### BEST MODE FOR CARRYING OUT THE INVENTION

The present invention can be applied to an electric toothbrush of any structure in which brushing is enabled by moving a tufted portion, provided that the product of the distance (mm) of movement of the tufted portion and the frequency (times) of back-and-forth motion per minute is set in the range of 3,000-9,000, preferably in the range of 4,500-7,500.

The present invention can be also applied to an electric toothbrush of any structure in which brushing is enabled by moving a tufted portion, the distance, x (mm), of movement of the tufted portion and the frequency, y (times), of back-and-forth motion per minute are set in a range satisfying the following formula.
y=ax+b,
Where a=−3000, 10,000≦b≦12,500, x>0.

The distance, x (mm), of movement of the tufted portion can be set at any value, but if it is too small, the plaque removal ratio decreases, and if the distance is too larger, the gum is easily damaged. Accordingly, the distance is preferably set at 0.3-0.7 mm.

The frequency of back-and-forth motion of the tufted portion per minute can be set at any value, but if it is too small, the sufficient brushing effect is not obtained, and if it is too large, special expensive parts have to be used. Accordingly, the frequency is preferably set at 8,000-13,000.

Even when the product of the distance (mm) of movement of the tuft and the frequency (times) of back-and-forth motion is not contained in the above-described range, or when the above-described formula y=ax+b is not valid, the specifications in which the distance (mm) of movement of the tufted portion is set at 0.3-0.7 mm and the frequency of back-and-forth motion of the tufted portion per minute is set at 8,000-13,000 can be contained in the present invention.

The electric toothbrush can have any specification, provided that the tufted portion is linearly moved. Thus, electric toothbrushes of various specifications can be utilized, examples thereof including an electric toothbrush comprising conversion means for converting the rotation movement of a motor via a crank mechanism into the back-and-forth linear movement of an output shaft connecting a replaceable brush thereon, or an electric toothbrush comprising conversion means for converting the rotation movement of a motor via a gear mechanism and a cam mechanism into the back-and-forth linear movement of an output shaft connecting a replaceable brush thereon.

An actual example of the electric toothbrush will be described below.

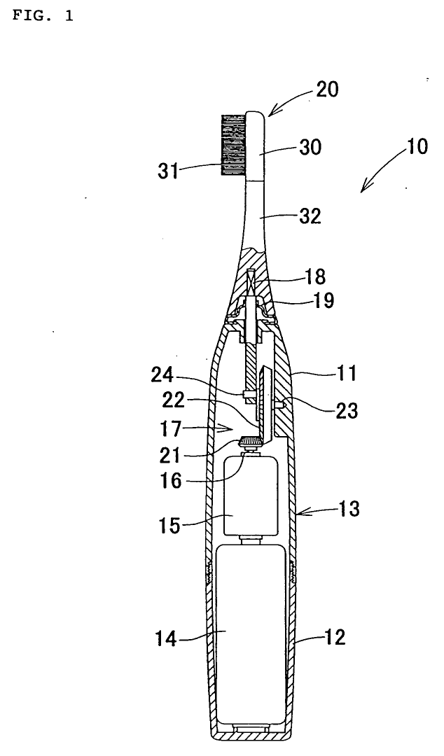

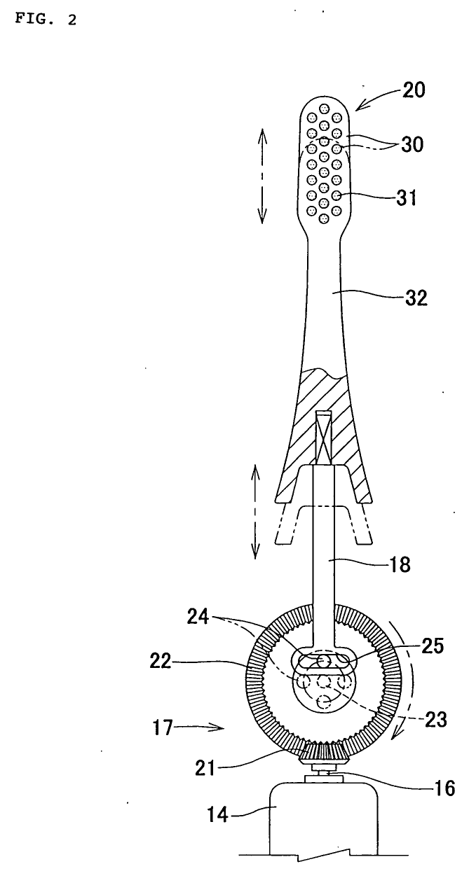

As shown in FIG. 1 and FIG. 2, an electric toothbrush 10 comprises a casing 13 also serving as a handle and having a structure partitioned into an upper casing 11 and a lower casing 12. The upper and lower casings 11, 12 are detachably joined.

A battery 14 is contained, so that it can be replaced, inside the lower portion of the casing 13, a DC electric motor 15 is incorporated in the intermediate portion of the casing 13. The motor 15 can be switched ON and OFF with a switch (not shown in the figure) assembled with the casing 13.

Conversion means 17 for converting the rotation movement of a rotation shaft 16 of the motor 15 into the linear movement in the vertical direction of the output shaft 18 is provided inside the upper portion of the casing 13. The output shaft 18 is provided so that it is able to move in the vertical direction through an upper wall portion of the casing 13 in the intermediate section thereof. A rubber cover 19 is provided in the upper end section of the casing 13 so as to prevent water or the like from penetrating from the sliding portion of the output shaft 18 and casing 13. A replaceable brush 20 is detachably mounted on the upper half of the output shaft 18 protruding upward from the casing 13.

The conversion means 17 will be explained below. A first bevel gear 21 is fixedly mounted on the rotation shaft 16 of the motor 15. A second bevel gear 22, which is engaged with the first bevel gear 21, is provided, so that it can rotate about a shaft section 23, in the inner wall section of the upper casing 11. A slit for cam 25 is provided in the horizontal direction in the lower end section of the output shaft 18, and an engagement pin 24 extending inside the slit 25 is protruded in the eccentric position of the second bevel gear 22. The rotation movement of the rotation shaft 16 of the motor 15 around the center of the axis in the vertical direction is converted by the first and second bevel gears 21, 22 into the rotation movement of the shaft section 23 around the axis center in the horizontal direction, and this rotation movement is converted into back-and-forth linear movement of the output shaft 18 in the vertical direction via the slit 25 and engagement pin 24.

The number of cog in the gears 21, 22 is set so that the back-and-forth linear movement (frequency of back-and-forth motion) of the output shaft 18 in the vertical direction within 1 min is within the mentioned range of frequency of back-and-forth motion. Furthermore, the eccentricity of the engagement pin 24 with respect to the shaft section 23 of the second bevel gear 22 is set so that the distance of movement of the replaceable brush 20 in the vertical direction (distance of movement of the tuft) is within the mentioned range of the distance of movement of the tuft.

The replaceable brush 20 has a well-known specification in which the tufted portion 31 is formed in the head 30 connecting neck portion 32 detachably connected the output shaft 18. Any shape of the head 30, number of tufts, and arrangement thereof can be set. Furthermore, a method by which the tufts constructed by the filaments are fixed into holes for tuft provided in the head by the anchor and fused by heat can be advantageously used as the method for fixing tufts. Furthermore, any material, diameter, length, or shape of the tip end of the filaments can be utilized. Moreover, filaments which constructed by one material or composite material may be utilized. If the filaments in which only the tip end is split into a plurality of portion are used, because the roots of filaments are stable, the motions can be sufficiently transmitted to the tips. Accordingly such a specification is preferred. Furthermore, because such filaments with split tips improve the plaque removal, it is preferred that the number of filaments with split tips be at least 30% of the total number of filaments.

A device used for evaluating the plaque removal ratio will be explained below. The device 40 has a structure identical to that of the device described in Japanese Patent Publication No. H10-239304.

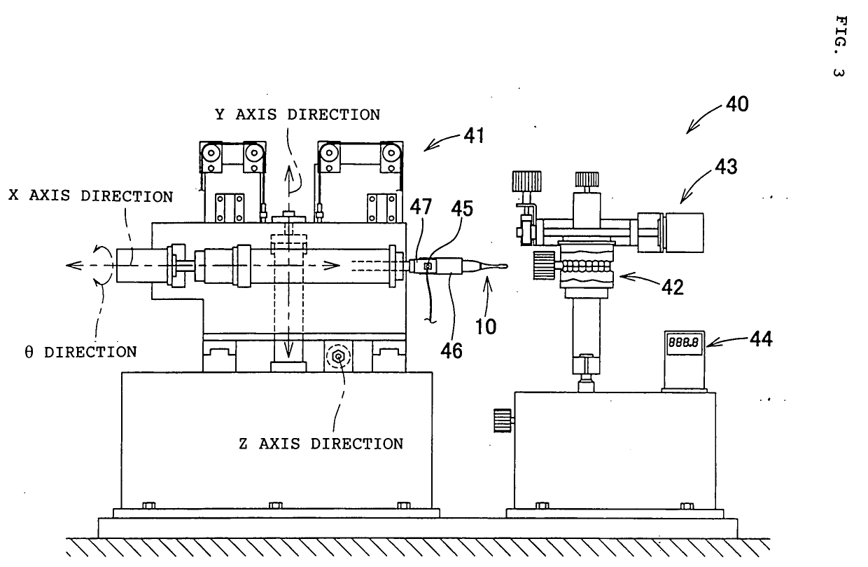

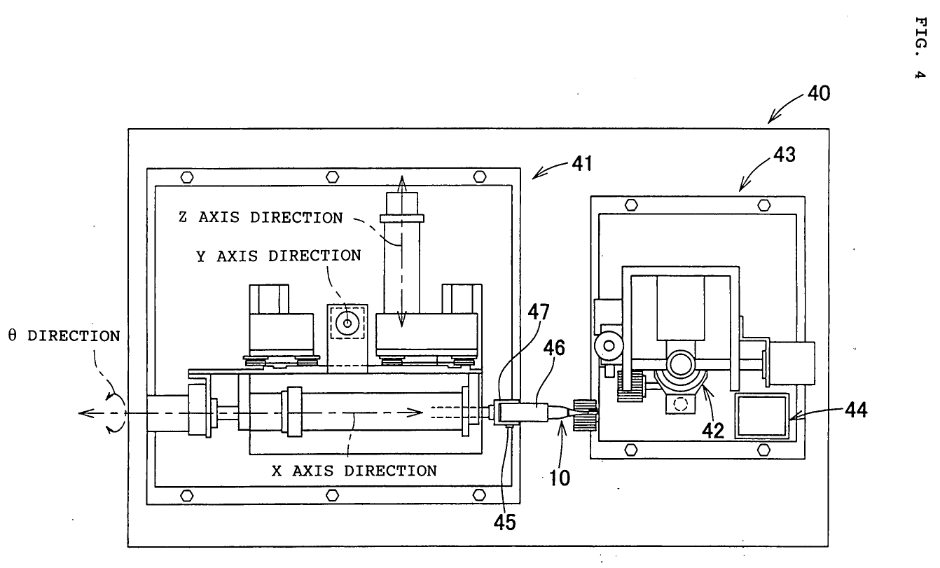

As shown in FIG. 3 and FIG. 4, the device 40 for evaluating the electric toothbrush 10 comprises operation means 41 for operating the electric toothbrush 10 in the three directions: X axis direction (left-right direction), Y axis direction (up-down direction), and Z axis direction (forward-backward direction), and rotating in the 0 direction around the X axis, in the state where the electric toothbrush 10, which is to be tested, is held in the X axis direction, control means (not shown in the figure) for controlling the operation means 41 so that the electric toothbrush 10 held in the operation means 41 performs brushing by the desired brushing method, holding means 43 for holding a dental model 42 so that the position thereof can be controlled, so that the desired teeth of the dental model 42 face the tufted portion 31 of the electric toothbrush 10 held in the operation means 41, and measurement means 44 for measuring the brushing pressure of the electric toothbrush 10 on the dental model 42.

The measurement means 44 measured the pressure (brushing pressure) acting upon the tufted portion 31 of the electric toothbrush 10 based on the output of a strain gage 45. The strain gage 45 has a well-known specification comprising a resistor from a metal or a semiconductor and is attached to the front surface of a support frame 47 of a holder 46 provided for securely holding the electric toothbrush 10 on the operation means 41.

The method for evaluation of the electric toothbrush will be described below.

Electric toothbrushes of three types with the distance of movement of the tuft caused by back-and-forth linear movement of the tufted portion set at 0.5 mm, 1.0 mm, and 3.0 mm were used as the electric toothbrush. Furthermore, a replaceable brush was manufactured by arranging tufts in 3 rows, 23 tufts with a tuft hole diameter of 1.6 mm and filaments with a diameter of 0.160 mm and a length of 10 mm. The tip portions of the filaments were trimmed to flat and were end-rounded.

Then, the electric toothbrushes of the above-described three types were used for brushing the dental model 42 under the below-described conditions by changing the frequency of back-and-forth motion of the tufted portion per minute in 6 stages: 1,000, 2,000, 5,000, 7,000, 10,000, and 11,000, and the removal ratio of artificial plaque that was coated to the teeth of the dental model 42 was measured. The frequency of back-and-forth motion indicates the number of back-and-forth linear movements, where one back-and-forth movement of the tufted portion is counted as 1 cycle. Furthermore, the frequency of back-and-forth motion was adjusted by conducting voltage control of the electric toothbrush.

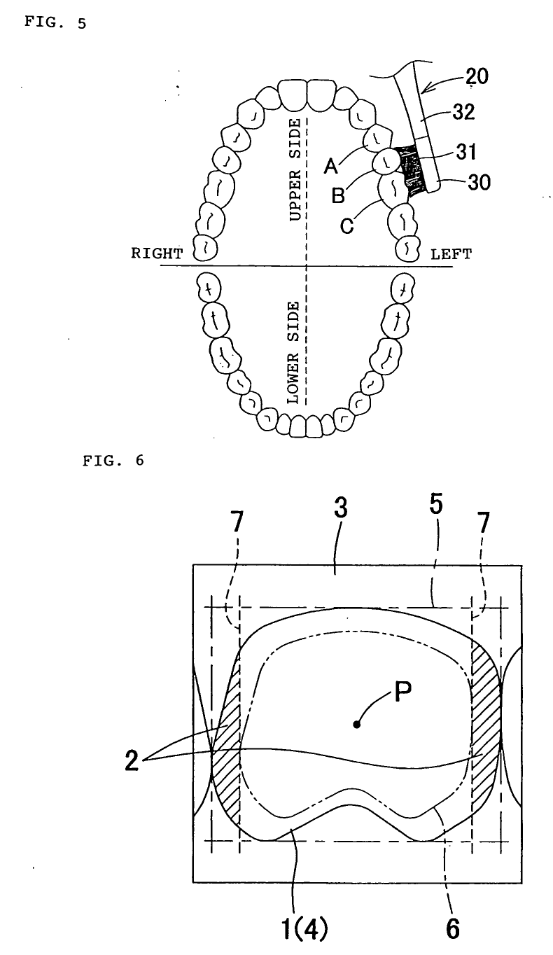

As shown in FIG. 5, the artificial plaque was coated on the 1st premolar A, second premolar B, and first molar C on the upper jaw side that were brushed in the dental model 42, the electric toothbrush 10 was driven at the prescribed frequency of back-and-forth motion, the brushing was conducted by moving the electric toothbrush from the first molar C to the first premolar A (forward) at a movement speed 3.16 mm/sec, under a brushing pressure of 150 g.

After the three teeth A, B, C of the dental model 42 have thus been brushed, the plaque removal ratio in the regions of interproximal portions of the teeth A, B, C that were set in the followings was found by image analysis. The results are shown in Table 1.

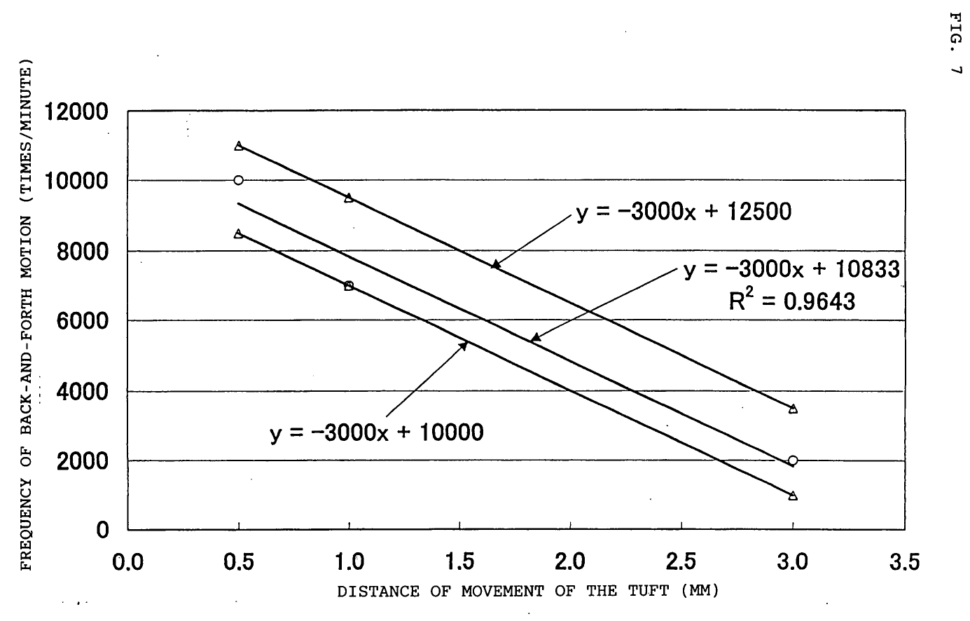

A method for setting a interproximal portion 2 of a tooth 1 will be explained below. As shown in FIG. 6, first, the buccal side surface of the tooth 1 downside from a gum 3 was picked up with a photographic means, and the center P of the rectangular frame 5, which is in contact with the outer shape of the standard image 4 of the tooth 1, was found. Then, the reduced image 6 obtained by reducing the standard image 4 to 80% was generated and the two images 4 and 6 were superimposed so that the centers P thereof were superimposed. The standard image 4 was then delineated with lines 7 that touch the reduced image 6 and the region shown by hatching on the outside of the lines 7 was set as an interproximal portion 2.

TABLE 1

| Frequency of | Distance of | | |
|---|---|---|---|
| back-and-forth | movement of | | |
| motions | tufts | Product of | |
| y (times) | x (mm) | x and y | Evaluation |
| 2000 | 0.5 | 1000 | X |
| 2000 | 1 | 2000 | X |
| 5000 | 0.5 | 2500 | X |
| 1000 | 3 | 3000 | Δ |
| 7000 | 0.5 | 3500 | Δ |
| 5000 | 1 | 5000 | ◯ |
| 10000 | 0.5 | 5000 | ◯ |
| 11000 | 0.5 | 5500 | ◯ |
| 2000 | 3 | 6000 | ◯ |
| 7000 | 1 | 7000 | ◯ |
| 10000 | 1 | 10000 | X |
| 5000 | 3 | 15000 | X |
| 7000 | 3 | 21000 | X |

<Standard for evaluation>
◯ Removal ratio is 50% or more
Δ Removal ratio is more than 36% and less than 50%
X Removal ratio is less than 36%

As shown in Table 1, when the product of the distance (mm) of movement of the tufted portion and the frequency (times) of back-and-forth motion per minute is 10,000 or more and 2,500 or less, the plaque removal ratio is 35% or less and sufficient plaque removal cannot be ensured, whereas an optimum state is obtained when this product is between 2,500 and 10,000. Furthermore, in the case of a patient with gingivitis, the distance of movement of the tuft has to be decreased, for example, when the distance of movement of the tuft is set at 0.5 mm, it is preferred that the frequency of back-and-forth motion per minute be set within a comparatively narrow range of 10,000 to about 11,000.

Furthermore, excellent plaque removal ratio was obtained when the distance (mm) of movement of the tufted portion and the frequency (times) of back-and-forth motion per minute were set as follows: the frequency of 10,000 at the distance 0.5 mm, 7,000 at 1.0 mm, and 2,000 at 3.0 mm. For this reason, the relationship between the distance, x (mm), of movement of the tufted portion and the frequency, y, of back-and-forth motion per minute in those three cases was approximated by a linear formula and the following formula was obtained.
y=−3000x+10833 (correlation factor: R²=0.9643)
Furthermore, the range was set under a proviso that the plaque removal ratio is 42% or higher, and the following formula was obtained.
y=ax+b.
where a=−3000, 10,000≦b≦12,500, x>0.

The graph is shown in FIG. 7. FIG. 7 demonstrates that the plaque removal ratio changed under the effect of the distance of movement of the tuft and frequency of back-and-forth motion, and at least when the distance of movement of the tuft is 0.5 mm to 3.0 mm and the frequency of back-and-forth motion is 2,000-10,000, it is preferred that the frequency of back-and-forth motion be set lower as the distance of movement of the tuft increases. Furthermore, in the case of a patient with gingivitis, sufficient plaque removal ratio can be ensured similarly to the common electric toothbrush by setting the frequency of back-and-forth motion appropriately, while avoiding the problem of damaging the gum by decreasing the distance of movement of the tuft.

1. An electric toothbrush in which brushing is enabled by back-and-forth linear movement of a tufted portion, wherein the product of the distance (mm) of movement of the tufted portion and the frequency (times) of back-and-forth motion per minute is set in the range of 3000-9000.

2. The electric toothbrush according to claim 1, wherein the product of the distance (mm) of movement of the tufted portion and the frequency (times) of back-and-forth motion per minute is set in the range of 4500-7500.

3. An electric toothbrush in which brushing is enabled by back-and-forth linear movement of a tufted portion, wherein the distance, x (mm), of movement of the tufted portion and the frequency, y (times), of back-and-forth motion per minute are set in a range satisfying the following formula.
y=ax+b,
Where a=−3000, 10,000≦b≦12500, x>0.

4. The electric toothbrush according to claim 1, wherein the distance of movement of the tufted portion is set at 0.3-0.7 mm.

5. The electric toothbrush according to claim 1, wherein the frequency of back-and-forth motion of the tufted portion is set at 8000 to 13000 per minute.

6. An electric toothbrush in which brushing is enabled by back-and-forth linear movement of a tufted portion, wherein the distance of movement of the tufted portion is set at 0.3-0.7 mm and the frequency of back-and-forth motion of said tufted portion is set at 8000 to 13000 per minute.

7. The electric toothbrush according to claim 1, wherein filaments in which tip portions of at least 30% or more of all tufted filaments are split into a plurality of portions are used.

8. The electric toothbrush according to claim 1, wherein a DC electric motor is used as means for moving said tufted portion.

9. The electric toothbrush according to claim 2, wherein the distance of movement of the tufted portion is set at 0.3-0.7 mm.

10. The electric toothbrush according to claim 3, wherein the distance of movement of the tufted portion is set at 0.3-0.7 mm.

11. The electric toothbrush according to claim 2, wherein the frequency of back-and-forth motion of the tufted portion is set at 8000 to 13000 per minute.

12. The electric toothbrush according to claim 3, wherein the frequency of back-and-forth motion of the tufted portion is set at 8000 to 13000 per minute.

13. The electric toothbrush according to claim 4, wherein the frequency of back-and-forth motion of the tufted portion is set at 8000 to 13000 per minute.

14. The electric toothbrush according to claim 2, wherein filaments in which tip portions of at least 30% or more of all tufted filaments are split into a plurality of portions are used.

15. The electric toothbrush according to claim 3, wherein filaments in which tip portions of at least 30% or more of all tufted filaments are split into a plurality of portions are used.

16. The electric toothbrush according to claim 4, wherein filaments in which tip portions of at least 30% or more of all tufted filaments are split into a plurality of portions are used.

17. The electric toothbrush according to claim 5, wherein filaments in which tip portions of at least 30% or more of all tufted filaments are split into a plurality of portions are used.

18. The electric toothbrush according to claim 6, wherein filaments in which tip portions of at least 30% or more of all tufted filaments are split into a plurality of portions are used.

19. The electric toothbrush according to claim 2, wherein a DC electric motor is used as means for moving said tufted portion.

20. The electric toothbrush according to claim 3, wherein a DC electric motor is used as means for moving said tufted portion.
